(19) United States
(12) Patent Application Publication
(10) Pub. No.: US 2015/0290716 A1
(43) Pub. Date: Oct. 15, 2015

(54) TOOL FOR MACHINING

(71) Applicants: Nadine Herberth, Kirchheim Teck (DE); Jose Agustin-Paya, Mulheim (DE)

(72) Inventors: Nadine Herberth, Kirchheim Teck (DE); Jose Agustin-Paya, Mulheim (DE)

(21) Appl. No.: 14/402,384

(22) PCT Filed: Jun. 27, 2013
(86) PCT No.: PCT/EP2013/063503

§ 371 Date: Nov. 20, 2014

(30) Foreign Application Priority Data
Jun. 28, 2012 (DE) 10 2012 012 908.4

(51) Int. Cl. B23B 27/10; B23B 27/16

(52) U.S. Cl. CPC B23B 27/10; B23B 27/1666; B23B 2205/02; B23B 2205/12; B23B 2250/12

(57) ABSTRACT

A tool (1) for machining, having a parent holder (11), an insert seat (5), a clamping shoe (4) having a clamping shoe arm (7) and an end-side clamping shoe head (8), and a cutting insert (10). In order both to increase the service life of the cutting inserts and to break the long chips that arise during cutting or to keep said chips short. The clamping shoe (4) is connected to the parent holder (11) and in the tool at least one coolant line (6) is passed through the parent holder (11) and the clamping shoe (4) as far as the clamping shoe head (8), said coolant line(s) leading into at least one discharge nozzle (3) on the clamping shoe head (8).

The invention relates to a tool for machining, comprising a basic holder, an insert seat, a clamping shoe and a cutting insert.

The tool and/or the tool system is/are suitable for machining metallic materials in particular, preferably ductile materials that are difficult to cut.

There are known tools, in which the cutting insert is secured with separate components, also known as clamping shoes or clamping fingers. Furthermore, tools having an internal coolant supply are also known. However, the discharge nozzles of these tools are located a distance away from the cutting edge of the cutting insert and are designed with a relatively large nozzle cross section, so they are not suitable for use under high pressures.

Furthermore, there are known tools in which the basic holder and the insert seat consist of one piece.

The object of the present invention is to improve upon a tool according to the preamble of claim 1, so that, on the one hand, the service life, i.e., the lifetime of the cutting inserts is increased and, on the other hand, the long chips formed during cutting are broken up and are kept short.

According to the invention, this is achieved by the features of claim 1.

The fact that the clamping shoe is connected to the basic holder and there is at least one liquid coolant line running in the tool, through the basic holder and the clamping shoe up to the clamping shoe head, opening into at least one discharge nozzle on the clamping shoe head, means that, on the one hand, the service life, i.e., the lifetime of the cutting inserts, is increased due to the liquid coolant carried through the clamping shoe and, on the other hand, the discharge nozzle(s) is/are aligned so that the emerging liquid coolant breaks the long chips formed in cutting and/or keeps them short.

The clamping shoe is preferably designed in one piece with the basic holder. However, the clamping shoe also known as a clamping finger may also be designed as a replaceable element (i.e., not in one piece). In this case, the clamping shoe must be attached to the basic holder in such a way that the liquid coolant lines are interconnected.

The head of the clamping shoe preferably has at least one end face, wherein the discharge nozzle(s) is/are arranged on the at least one end face. In the case of multiple end faces, they are preferably positioned at an angle to one another.

In one advantageous embodiment, the discharge nozzle(s) is/are arranged in a top and/or bottom discharge nozzle row, wherein the position relative to the cutting insert surface is designated as either “top” or “bottom.” The liquid coolant is therefore aimed directly at the cutting edge of the cutting insert, and the liquid coolant from the discharge nozzle(s) in the top discharge nozzle row is aimed at the resulting chips.

In one embodiment, two discharge nozzles are arranged in the top discharge nozzle row and four discharge nozzles are arranged in the bottom discharge nozzle row. Any number of discharge nozzles may be provided, depending on the available space.

The discharge nozzles can be arranged in any desired manner. In a preferred embodiment, the discharge nozzle(s) on the bottom discharge nozzle row are directed at the cutting edge of the cutting insert and/or the discharge nozzle(s) on the top discharge nozzle row are directed at the workpiece to be machined, in particular at the chips formed during the cutting. The chips are therefore kept small.

The two rows of discharge nozzles may be oriented in accordance with requirements. The two rows of discharge nozzles preferably form an angle β greater than 80° and smaller than 160°. The angle β is preferably between 120° and 160°. The discharge nozzles can be oriented in a targeted manner in this way.

The distance a from the discharge nozzle(s) to the cutting edge of the cutting insert is preferably in the range of 1.5 to 10 mm, preferably 3 to 5 mm. The liquid coolant thus immediately strikes the cutting edge and the chips after emerging from the discharge nozzle(s).

The diameter of the liquid coolant line is preferably 0.5-3.0 mm, preferably 1.0-1.5 mm. A high pressure can be maintained in this way and a sufficient amount of liquid coolant can be conveyed to the discharge nozzle(s).

The clamping shoe is preferably made of steel and the clamping shoe head is made of a hard material, preferably a ceramic or hard metal, and is mounted as an add-on part, preferably replaceably, on the clamping shoe arm. The clamping shoe head may also have an end face guard made of a hard material, preferably ceramic or hard metal. This prolongs the service life.

The clamping shoe arm, in particular the clamping shoe head, is designed to be flexible with respect to the basic holder when the cutting insert is not clamped in place, preferably by a material recess at the transition to the basic holder. This facilitates the cutting of the cutting insert.

In one embodiment of the invention, the insert seat is designed in one piece in a U shape with an insert seat central section and two insert seat legs arranged at the ends of the insert seat central section, one insert seat leg being designed as an L-shaped insert seat leg with a hook arranged on the end, and the hook is designed to be essentially perpendicular to the insert seat leg. This embodiment permits replaceability of the insert seat on the basic holder.

The hook-shaped design may also be angular or defined as a curved line.

In one embodiment of the invention, the undercut has an inclination or a curved line and the hook has an opposite inclination or an opposite curve line adapted thereto, and the opposite inclination is in contact with the inclination or the curved line is in contact with the opposite curved line in the installed state of the insert seat. Even if the insert seat were not secured by screws on the basic holder, it could not slip forward in the direction of the tool. This facilitates the hold and the precise positioning of the insert seat.

For further anchoring of the insert seat on the basic holder, a first borehole is created in each of the clamping shoe arm and the L-shaped insert seat leg so that they are aligned with one another and a first threaded borehole also aligned therewith is provided in the basic holder. The insert seat can therefore be anchored by a screw on its top end facing the clamping shoe.

A second borehole may be provided in the non-L-shaped insert seat leg, either additionally or by itself, this borehole being designed to be aligned with a second threaded borehole in the basic holder. In this way, the insert seat can be anchored by a screw on its bottom end facing away from the clamping shoe. This bottom end may also be designed to be wedge-shaped.

The invention is explained in greater detail below on the basis of seven figures, in which:

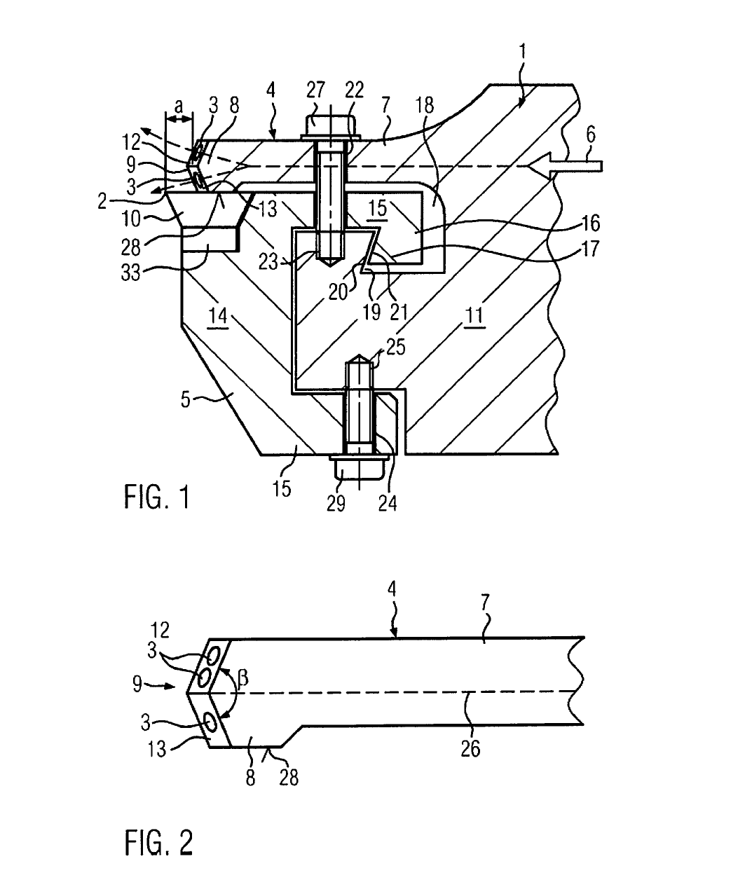

FIG. 1 shows a section through one variant of a tool 1 according to the invention,

FIG. 2 shows the end part of a clamping shoe arm 7,

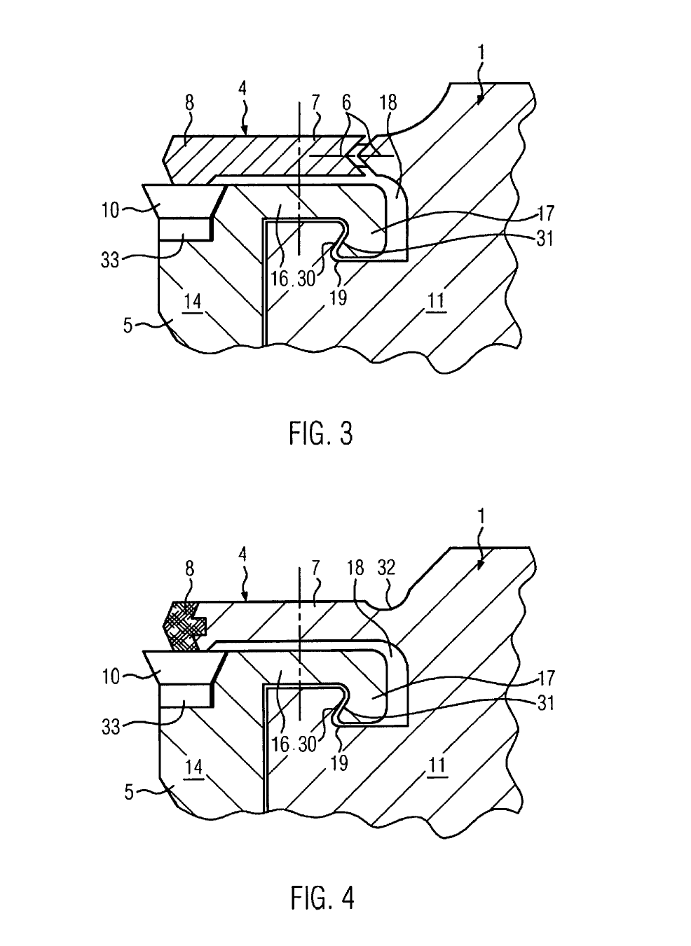

FIG. 3 shows a section through a tool 1 according to the invention with a clamping shoe attached to the basic holder,

FIG. 4 shows a section through a tool 1 according to the invention with a clamping shoe head as an add-on part,

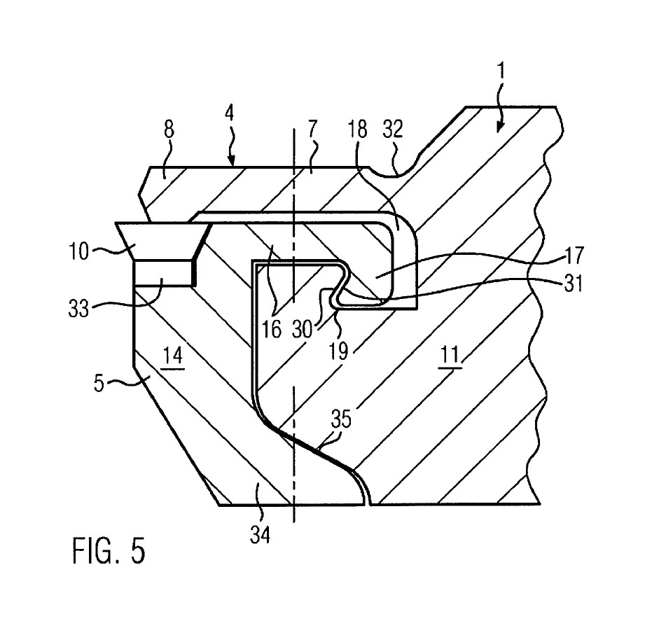

FIG. 5 shows a section through a tool 1 according to the invention with a curved line and an opposite curved line on the hook and/or on the undercut,

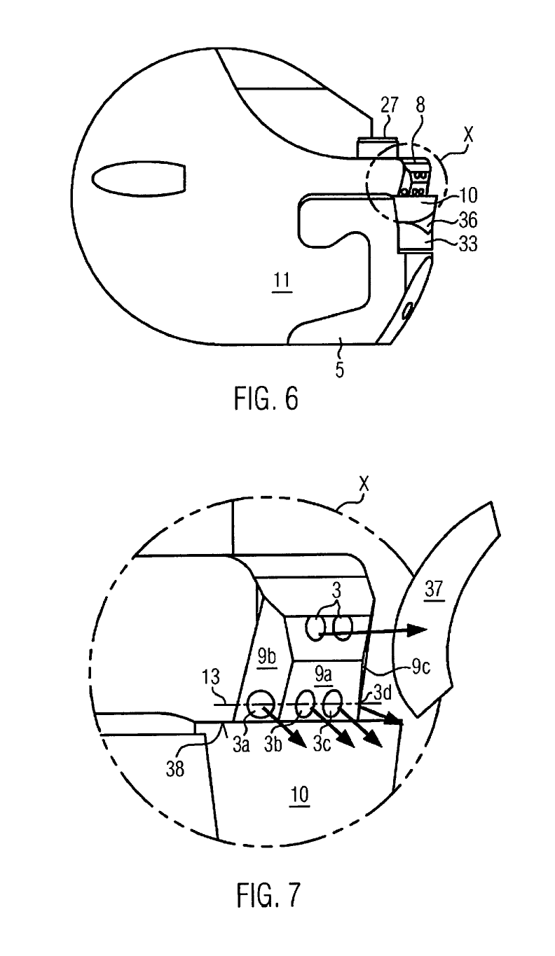

FIG. 6 shows a section through an alternative tool 1 according to the invention and

FIG. 7 shows the region X of the clamping shoe head from FIG. 6 enlarged.

FIG. 1 shows, in one section, a part of a tool 1 according to the invention. This tool 1 consists of a basic holder 11 on which a cutting insert 10 is attached to an insert seat 5 by means of a clamping shoe 4.

The clamping shoe 4 is designed in one piece with the basic holder 11 and consists of a clamping shoe arm 7 which develops into the basic holder 11, on the one hand, and, on the other hand, has a clamping shoe head 8 on its end. The clamping shoe arm 7 is long enough that it is slightly flexible. The clamping shoe head 8 rests on the cutting insert 10, with the cutting insert 10 inserted and secured, and presses the latter against a replaceable insert seat 5, which is described in greater detail below. A first borehole 22 for clamping the cutting insert 10 by means of a tension screw 27 is arranged in the clamping shoe arm 7. This will be discussed in detail below.

The clamping shoe head 8 has a supporting surface 28 which rests on the cutting insert 10 when the latter is inserted. Furthermore, the cutting insert head 8 has an end face 9 which is arranged essentially perpendicular to the longitudinal axis 26 (see FIG. 2) of the clamping shoe arm 7. FIG. 2 shows this enlarged.

Discharge nozzles 3 which are connected to at least one liquid coolant line 6 in the clamping shoe 4 are arranged on this end face 9. Liquid coolant is passed through this liquid coolant line 6 to directly up to the cutting insert. The liquid coolant line 6 extends through the basic holder 11 and the clamping shoe arm 7 as far as the discharge nozzles 3 on the end face 9 of the clamping shoe head 8.

The individual discharge nozzles 3 have a cross section/diameter range of 0.5-3.0 mm, preferably 1.0-1.5 mm. They are therefore suitable for high pressures.

The tool 1 is designed so that the liquid coolant flows through the liquid coolant line 6 under a high pressure (30-400 bar) through the tool 1 into the immediate vicinity of the cutting edge 2 of the cutting insert 10. The distance a (see FIG. 1) of the discharge nozzles 3 to the cutting insert 2 is in the range of 1.5-10 mm, preferably 3-5 mm.

At least three of these discharge nozzles 3 are preferably provided on the end face 9 of the clamping shoe head 8, wherein a bottom discharge nozzle row 13 and a top discharge nozzle row 12 are always formed. The terms “top” and “bottom” refer to the positions in relation to the cutting insert surface. In the case of the minimum number of three discharge nozzles 3, two discharge nozzles 3 are arranged at the bottom and one discharge nozzle 3 is arranged at the top. If there are more than three discharge nozzles 3 on the end face 9 of the clamping shoe head 8, then any variant of possible combinations may be defined with a number of top and bottom discharge nozzles 3, depending on the application.

The particular feature of the present invention lies in the fact that the liquid coolant is passed through the basic holder 11 and through the clamping shoe 4. The basic holder 11 and the clamping shoe 4 preferably form a single unit but may also consist of two or more components, such as a basic holder 11 and a separate clamping shoe. When attaching the clamping shoe, care must be taken to ensure that the liquid coolant lines 6 of the two parts merge into one another.

The discharge nozzle(s) 3 in the bottom discharge nozzle row 13 is/are preferably directed at the cutting edge 2 of the cutting insert 10, and the discharge nozzle(s) 3 in the top discharge nozzle row 12 is/are preferably directed at the workpiece to be machined, in particular at the chips formed by cutting.

Another particular feature of the invention is that the insert seat 5, also referred to as a turning insert seat, may be replaced. The cutting inserts 10 are preferably turning cutting inserts. In order for the insert seat 5 to be replaceable, the basic holder 11 has an L-shaped recess 18 with an undercut 19 below the clamping shoe 4. An inclination 20 is formed on this undercut 19.

The insert seat 5 is designed in a U-shape with an insert seat central section 14 and insert seat legs 15 leading away from the insert seat central section 14, essentially at a right angle, at each of the two ends of the insert seat central section 14. A recess is provided on the insert seat central section 14 for direct accommodation of a cutting insert 10 or indirect accommodation by means of an intermediate piece. The cutting insert preferably has on its bottom side a prism, which is arranged in a recess in the insert seat 5 adapted thereto or an insert seat receptacle 33. Due to this prism, the cutting insert is securely anchored with any side forces that may occur. This prismatic design is advantageous for all the embodiments that are presented. However, other types of turning plates of a variety of shapes and sizes may also be used here.

In order for the insert seat 5 to be anchorable on the basic holder without being fastened by a tension screw, an insert seat leg 15 is designed as an L-shaped insert seat leg 16. L-shaped here means that a hook 17 forming essentially a right angle is arranged on the end of the insert seat leg 15. The insert seat leg 15 together with the hook 17 forms the L-shaped insert seat leg 16. The hook 17 has an opposite inclination 21 on its side facing the basic holder 11, this opposite inclination being matched to the inclination 20 on the undercut 19.

The insert seat 5 can be inserted into the L-shaped recess 18 on the basic holder 5 at the side, perpendicular to the longitudinal axis 26 of the clamping shoe 4, such that the hook 17 becomes hooked on the L-shaped insert seat leg 16 with the undercut 19. Due to this hook engagement, the insert seat 5 cannot slip forward, i.e., in the direction of the workpiece to be machined.

For further fastening, but primarily for cutting the cutting insert 10 on the insert seat 5, a first borehole 22 aligned with the others is provided in the clamping shoe arm 7 and in the L-shaped insert seat leg 16, such that an aligned first borehole 23 is arranged in the basic holder 11. The clamping shoe 4 and/or the clamping shoe arm 7 can be pressed in the direction of the cutting insert 10 by means of a tension screw 27, which is screwed through the first borehole 22 into the first threaded borehole 23, so that the cutting insert 10 is forced onto the insert seat 5 or the insert seat receptacle 33 is forced onto the insert seat and put under tension there.

In addition, a second borehole 24 may preferably also be created in the insert seat leg that is not L-shaped and develops into a second borehole 25 aligned with it. The insert seat 5 can be anchored additionally with an additional tension screw 29 in this way.

FIG. 2 shows a cross section of an enlarged detail of the clamping shoe arm 7. To simplify the drawing, FIG. 2 does not show the liquid coolant lines 6. However, it does show the clamping shoe head 8 with the discharge nozzles 3 on the end face 9. This shows well that the discharge nozzles 3 are arranged in two discharge nozzles rows 12, 13. In the embodiment shown here, two discharge nozzles 3 are arranged in the top discharge nozzle row 12 and one discharge nozzle is arranged in the bottom discharge nozzle row 13. The two rows 12, 13 of discharge nozzles can each be aligned according to requirements. In the embodiment shown in FIG. 1, the two rows 12, 13 of discharge nozzles form an angle β=150°. One angle β is preferably greater than 80° and less than 160°. One angle β is particularly preferably between 120° and 160°. This makes it possible to align the discharge nozzles 3 in a targeted manner.

FIG. 3 shows a section through a tool 1 according to the invention with a clamping shoe 4 attached to the basic holder 11. In this embodiment, the clamping shoe 4 forms a separate part and is not in one piece with the basic holder 11, as shown in the embodiment according to FIG. 1. In the fastening of the clamping shoe 4 to the basic holder 11, care should be taken to ensure that the liquid coolant lines 6 are connected to one another. Another difference in comparison with the embodiment according to

FIG. 1 is that the inclination 20 is replaced here by a curved line 30 and the opposite inclination 21 is replaced by an opposite curve line 31. Otherwise there is no difference in comparison with the embodiment according to FIG. 1. The same reference numerals are used for the same parts.

FIG. 4 shows a section through a tool 1 according to the invention with a clamping shoe 4 attached to the basic holder 11 and designed in one piece with the basic holder 11 as in the embodiment according to FIG. 1. A material recess 32 is arranged at the transition from the clamping shoe arm 7 to the basic holder 11, in order for the clamping shoe to be flexible. In this embodiment, the material recess 32 is designed to be hemispherical. Otherwise this embodiment differs in that the clamping shoe head 8 is connected to the clamping shoe arm 7 as a separate component made of ceramic, for example. Another difference in comparison with the embodiment according to FIG. 1 is that the inclination 20 here is replaced by a curve line 30 and the opposite inclination 21 is replaced by an opposite curve line 31. There is otherwise no difference from the embodiment according to FIG. 1. The same reference numerals are used for the same parts.

FIG. 5 shows a section through a tool 1 according to the invention with a clamping shoe 4 attached to basic holder 11. In this embodiment the insert seat leg 34 which is not L-shaped is designed in a wedge shape as is also the adjacent region 35 of the basic holder 11.

In all the embodiments shown here, the cutting insert 10 sits on an insert seat receptacle 33 and thus in turn sits on the insert seat 5. In all the embodiments shown here the cutting insert 10 has a wedge 36 on its underside (see FIG. 6) and the insert seat receptacle 33 has a recess adapted thereto. This wedge 36 is also referred to as a prism.

FIG. 6 shows a section through a tool 1 according to the invention having a special clamping shoe head 8. FIG. 7 shows the region X from FIG. 6 with the clamping shoe head 8 from FIG. 6 enlarged.

The clamping shoe head 8 according to FIGS. 6 and 7 has a plurality of end faces 9 which are bent at angles to one another. An end-side face 9b and 9c leads away from a front end face 9a in each case. Four discharge nozzles 3a, 3b, 3c are arranged on this end face 9a and side end-side faces 9b, 9c, all these nozzles being arranged on a bottom discharge nozzle row 13. This bottom discharge nozzle row 13 runs parallel to the top side 38 of the cutting insert 10. A top discharge nozzle row 12 runs above the bottom discharge nozzle row 13, with two discharge nozzles 3 being arranged on this top row. This top discharge nozzle row 12 also runs parallel to the top side 38 of the cutting insert 10. As FIG. 7 shows clearly, the four discharge nozzles 3a, 3b, 3c, 3d are directed at the cutting insert 10, preferably at the cutting edge of the cutting insert 10. The two discharge nozzles 3 on the top discharge nozzle row 12 are directed at the chips 37 that are formed. The chips are kept small in this way.

The present invention is characterized in that machining operations are optimized so that

A) the lifetime of the cutting inserts 10 is increased,

B) the long chips are kept short and

C) the insert seat 5 can be replaced individually, as needed.

The term “cutting plate” is understood in general to refer to a “cutting insert” and vice-versa.

1-17. (canceled)

18. A tool for machining comprising:
a basic holder;
an insert seat;
a clamping shoe having a clamping shoe arm and a clamping shoe head on an end; and
a cutting insert;
wherein the clamping shoe is connected to the basic holder and at least one liquid coolant line which opens into a discharge nozzle on the clamping shoe head is carried in the tool through the basic holder and the clamping shoe up to the clamping shoe head.

19. The tool according to claim 18, wherein the clamping shoe is designed in one piece with the basic holder.

20. The tool according to claim 18, wherein the clamping shoe head has at least one end face wherein the discharge nozzle is arranged on the at least one end face.

21. The tool according to claim 18, wherein the clamping shoe head has a plurality of end faces angled relative to one another.

22. The tool according to claim 18, wherein the discharge nozzle is arranged on a top discharge nozzle row or a bottom discharge nozzle row, relative to the surface of the cutting insert.

23. The tool according to claim 18, wherein two of said discharge nozzles are arranged on a top discharge nozzle row and four discharge nozzles are arranged on a bottom discharge nozzle row.

24. The tool according to claim 22, wherein the discharge nozzle on the bottom discharge nozzle row is directed at the cutting edge of the cutting insert, and the discharge nozzle on the top discharge nozzle row is directed at a workpiece to be machined.

25. The tool according to claim 18, wherein, a distance a from the discharge nozzle to the cutting edge of the cutting insert is in the range of 1.5-10 mm.

26. The tool according to claim 18, wherein the diameter of the liquid coolant line is from 0.5 to 3.0 mm.

27. The tool according to claim 18, wherein the clamping shoe is made of steel and the clamping shoe head is made of a hard material, preferably ceramic or a hard metal and is attached as an add-on part to the clamping shoe arm.

28. The tool according to claim 18, wherein the clamping shoe head is designed to be flexible with respect to the basic holder when the cutting insert is not clamped in place, preferably by means of a material recess at the transition to the basic holder.

29. The tool according to claim 18, wherein the insert seat is designed in one piece in a U shape with an insert seat central section and two insert seat legs each arranged at the ends of the insert seat central section, wherein one insert seat leg is designed as an L-shaped insert seat leg having a hook arranged at the end, and the hook is designed to be essentially perpendicular to the insert seat leg.

30. The tool according to claim 29, wherein the basic holder has an L-shaped recess with an undercut below the clamping shoe, and the insert seat can be inserted laterally into the L-shaped recess, so that it is perpendicular to the longitudinal axis of the clamping shoe, and the hook on the L-shaped insert seat leg engages with the undercut.

31. The tool according to claim 30, wherein the undercut has an inclination or a curved line and the hook has an opposite inclination or an opposite curve line that is matched to the former, and in the installed state of the insert seat, the opposite inclination is in contact with the inclination or the curve line is in contact with the opposite curve line.

32. The tool according to claim 29, wherein a first borehole aligned with the others is created in the clamping shoe arm and in the L-shaped insert seat leg, and they are aligned with one another and a first threaded borehole, which is aligned therewith is arranged in the basic holder.

33. The tool according to claim 29, wherein a second borehole is arranged in the insert seat leg that is not L-shaped and it is designed with a second threaded borehole in the basic holder so that it is aligned therewith.

34. The tool according to claim 29, wherein insert seat leg that is not L-shaped is wedge-shaped.
